(19) United States
(12) Patent Application Publication
(10) Pub. No.: US 2016/0347928 A1
(43) Pub. Date: Dec. 1, 2016

(54) RUBBER COMPOSITION, AND SHEET CONVEYING ROLLER PRODUCED BY USING THE RUBBER COMPOSITION

(71) Applicant: SUMITOMO RUBBER INDUSTRIES, LTD., Kobe-shi (JP)

(72) Inventor: Masashi HAMAKUBO, Kobe-shi (JP)

(73) Assignee: SUMITOMO RUBBER INDUSTRIES, LTD., Kobe-shi (JP)

(21) Appl. No.: 15/144,157

(22) Filed: May 2, 2016

(30) Foreign Application Priority Data
Jun. 1, 2015 (JP) 2015-111668

(51) Int. Cl. C08K 3/36; C08K 3/26

(52) U.S. Cl. CPC C08K 3/36; C08K 3/26; C08K 2003/265

(57) ABSTRACT

A novel rubber composition is provided, which contains an EPDM, a peroxide crosslinking. agent and amorphous silica in combination, and can be imparted with a light color such as white or a non-black color and formed into a sheet conveying roller excellent in mechanical properties because the crosslinking of the EPDM is not inhibited. A sheet conveying roller formed from the rubber composition is also provided. The rubber composition contains a rubber component including an EPDM, a peroxide crosslinking agent, not less than 10 parts by mass of amorphous silica based on 100 parts by mass of the rubber component, and calcium carbonate. The sheet conveying roller (1) is formed from the rubber composition.

### TECHNICAL FIELD

The present invention relates to a rubber composition, and to a sheet conveying roller produced by using the rubber composition.

### BACKGROUND ART

In general, carbon black is used as a rubber reinforcing agent. The carbon black is black as implied by its name and, hence, a molded rubber product containing the carbon black is basically black. Therefore, the carbon black is not suitable for production of a molded rubber product having a light color such as white or a non-black color.

Particularly, a sheet conveying roller produced as a molded rubber product to be incorporated in an electrophotographic image forming apparatus such as a laser printer, or an ink jet printer, an automatic teller machine (ATM) or the like preferably has a non-black color for preventing a paper sheet from being smeared with a friction trace.

The influence of the color of the carbon black may be conceivably suppressed by reducing the proportion of the carbon black. In this case, however, the reinforcing effect of the carbon black is insufficient. Therefore, the sheet conveying roller is problematically poorer in mechanical properties (e.g., tensile properties such as tensile strength and breakage elongation, wear resistance, permanent elongation, strain resistance properties such as compression set, and the like).

To cope with this, it is contemplated to blend amorphous silica serving as a white reinforcing agent having the highest reinforcing effect instead of the carbon black or together with other reinforcing agent and filler such as the carbon black and titanium oxide.

Further, the sheet conveying roller is required to be excellent in ozone resistance and weather resistance for use in an image forming apparatus, and required to be excellent in weather resistance, anti-aging property, cold resistance and lower-temperature property to ensure stable performance when being incorporated in an ATM which may be installed in various places. Therefore, an ethylene propylene diene rubber (EPDM) which is excellent in these properties is often used for production of the sheet conveying roller.

Where the amorphous silica is blended as the reinforcing agent in a system containing the EPDM as a rubber component and a peroxide crosslinking agent as a crosslinking component, however, the amorphous silica inhibits the crosslinking of the EPDM with the peroxide crosslinking agent, making it impossible to produce a sheet conveying roller having sufficient mechanical properties.

Where the rubber component includes the EPDM alone, the crosslinking is entirely impossible. Where other rubber is used in combination with the EPDM as the rubber component, the other rubber can be crosslinked but the EPDM cannot be crosslinked. In either case, it is impossible to impart the sheet conveying roller with sufficient mechanical properties.

### CITATION LIST

### Patent Document

Patent Document 1: JP2003-261728A

### SUMMARY OF THE INVENTION

### Problem to be Solved by the Invention

It is an object of the present invention to provide a novel rubber composition which contains at least an EPDM as a rubber component, a peroxide crosslinking agent as a crosslinking component and at least amorphous silica as a reinforcing agent, and can be imparted with a light color such as white or a non-black color and formed into a sheet conveying roller excellent in mechanical properties because the crosslinking of the EPDM is not inhibited. It is another object of the present invention to provide a sheet conveying roller produced by using the rubber composition.

### Solution to Problem

The present invention provides a rubber composition which comprises a rubber component including an ethylene propylene diene rubber, a peroxide crosslinking agent, calcium carbonate, and not less than 10 parts by mass of amorphous silica based on 100 parts by mass of the rubber component.

The present invention further provides a sheet conveying roller produced from the inventive rubber composition.

### Effects of the Invention

According to the present invention, the novel rubber composition which contains at least the EPDM as the rubber component, the peroxide crosslinking agent as a crosslinking component and at least the amorphous silica as a reinforcing agent can be imparted with a light color such as white or a non-black color, and formed into a sheet conveying roller excellent in mechanical properties because the crosslinking of the EPDM is not inhibited. Further, the sheet conveying roller produced by using the inventive rubber composition is provided.

### BRIEF DESCRIPTION OF THE DRAWINGS

FIG. 1 is a perspective view illustrating an exemplary sheet conveying roller according to one embodiment of the present invention.

FIG. 2 is a diagram for explaining how to measure the friction coefficients of sheet conveying rollers produced by using rubber compositions of inventive examples and comparative examples.

### EMBODIMENTS OF THE INVENTION

<<Rubber Composition>>

The inventive rubber composition contains a rubber component including an EPDM, a peroxide crosslinking agent, calcium carbonate, and not less than 10 parts by mass of amorphous silica based on 100 parts by mass of the rubber component.

The inventive rubber composition is prepared by blending the calcium carbonate in a system containing at least the rubber component including the EPDM, the peroxide crosslinking agent and the amorphous silica as a reinforcing agent. As apparent from inventive examples and comparative examples to be described later, the calcium carbonate substantially prevents the amorphous silica from inhibiting the crosslinking of the EPDM by the peroxide crosslinking agent, making it possible to sufficiently crosslink the rubber component including the EPDM.

The reinforcing effect of the amorphous silica and the filling effect of the calcium carbonate functioning as a filler synergistically make it possible to produce a sheet conveying roller excellent in mechanical properties as compared with the prior art.

In addition, the calcium carbonate has a white color or alight color, and the silica has a white color. This makes it possible to impart the sheet conveying roller with a light color such as white or a non-black color.

In the present invention, the proportion of the amorphous silica is limited to not less than 10 parts by mass based on 100 parts by mass of the rubber component for the following reason. If the proportion of the amorphous silica is less than the aforementioned range, the reinforcing effect of the amorphous silica is liable to be insufficient, making it impossible to impart the sheet conveying roller with sufficient mechanical properties.

Patent Document 1 states that silica and calcium carbonate may be blended as a reinforcing agent and a filler in a system containing an ethylene propylene rubber (EPM) and a peroxide crosslinking agent in combination.

However, Patent Document 1 describes neither that the crosslinking of the EPDM with the peroxide crosslinking agent is inhibited by the silica nor that the inhibition of the crosslinking of the EPDM is suppressed by using the calcium carbonate in combination with the silica, and does not provide an inventive example that proves the aforementioned effects of the combinational use of the silica and the calcium carbonate.

In addition, Patent Document 1 employs the EPM as the rubber component, but denies the use of the EPDM in the prior art. Therefore, Patent Document 1 neither teaches nor suggests the combinational use of the silica and the calcium carbonate as intended in the present invention.

### <EPDM>

Usable as the EPDM are various EPDMs which are prepared by introducing double bonds to a main chain of the EPDM by addition of a small amount of a third ingredient (diene) to ethylene and propylene.

A variety of EPDM products produced, for example, by using different types and different amounts of the third ingredient are commercially available. Typical examples of the third ingredient include ethylidene norbornene (ENB), 1,4-hexadiene (1,4-HD) and dicyclopentadiene (DCP).

The EPDMs include those of an oil-extension type having flexibility controlled by addition of an extension oil, and those of a non-oil-extension type containing no extension oil. In the present invention, either type of EPDM is usable.

These EPDMs may be used alone or in combination.

### <Other Rubber>

The EPDM (which may include two or more types of EPDMs) is preferably used alone as the rubber component for improvement of the ozone resistance and the like of the sheet conveying roller as described above and for simplification of the formulation of the rubber composition for cost reduction.

However, other rubber may be used in combination with the EPDM as the rubber component.

Examples of the other rubber include a natural rubber, an isoprene rubber (IR) and a styrene butadiene rubber (SBR), which may be used alone or in combination. The SBR may be classified in an oil-extension type having flexibility controlled by addition of an extension oil or in a non-oil-extension type containing no extension oil. In the present invention, either type of SBR is usable.

The combinational use of the other rubber and the EPDM suppresses the reduction in the friction coefficient μ of the sheet conveying roller which may otherwise occur due to accumulation of paper dust when a sheet feeding operation is repeatedly performed, and improves the wear resistance of the sheet conveying roller.

Where the other rubber is used in combination with the EPDM, the proportion of the other rubber is preferably not greater than 50 parts by mass, particularly preferably not greater than 40 parts by mass, based on 100 parts by mass of the overall rubber component.

If the proportion of the other rubber is greater than the aforementioned range, the proportion of the EPDM is relatively reduced, so that the effect of the use of the EPDM for improving the ozone resistance of the sheet conveying roller and the like is liable to be insufficient.

In order to properly provide the aforementioned effect of the combinational use of the EPDM and the other rubber, the proportion of the other rubber is preferably not less than 5 parts by mass, particularly preferably not less than 10 parts by mass, based on 100 parts by mass of the overall rubber component within the aforementioned range.

Where at least one of the EPDM and the other rubber is of the oil-extension type, the proportion of the oil-extension type rubber is defined based on the solid amount of the rubber calculated by subtracting the amount of the extension oil contained in the oil-extension type rubber from the amount of the oil-extension type rubber.

### <Peroxide Crosslinking Agent>

Examples of the peroxide crosslinking agent include benzoyl peroxide, 1,1-bis(tert-butylperoxy)-3,3,5-trimethylcyclohexane, 2,5-dimethyl-2,5-di(benzoylperoxy)hexane, di(tert-butylperoxy)diisopropylbenzene, 1,4-bis[(tert-butyl)peroxyisopropyl]benzene, di(tert-butylperoxy)benzoate, tert-butylperoxybenzoate, dicumyl peroxide (DCP), tert-butyl cumyl peroxide, 2,5-dimethyl-2,5-di(tert-butylperoxy)hexane, di-tert-butyl peroxide and 2,5-dimethyl-2,5-di(tert-butylperoxy)-3-hexene, which may be used alone or in combination.

The proportion of the peroxide crosslinking agent is preferably not less than 1 part by mass and not greater than 10 parts by mass, particularly preferably not greater than 5 parts by mass, based on 100 parts by mass of the overall rubber component.

If the proportion of the peroxide crosslinking agent is less than the aforementioned range, the crosslinking is liable to be insufficient, making it impossible to impart the sheet conveying roller with proper mechanical properties.

If the proportion of the peroxide crosslinking agent is greater than the aforementioned range, on the other hand, the intended effect will not be further enhanced, but scorching is liable to occur during the processing and the molding of the rubber composition.

Where the proportion of the peroxide crosslinking agent falls within the aforementioned range, in contrast, the rubber component can be sufficiently crosslinked without the scorching, thereby imparting the sheet conveying roller with excellent mechanical properties.

Where at least one of the EPDM and the other rubber is of the oil-extension type, the proportion of the peroxide crosslinking agent is based on 100 parts by mass of the overall rubber component that is calculated by subtracting the amount of the extension oil contained in the oil-extension type rubber from the total amount of the rubbers.

The proportions of the following ingredients are also based on 100 parts by mass of the overall rubber component that is calculated in the same manner.

### <Amorphous Silica>

Usable examples of the amorphous silica include wet silica and dry silica, which are classified according to the production method thereof. Hydrophobic amorphous silica is also usable.

Specific examples of the amorphous silica include Nipsil (registered trade name) series amorphous silica products available from Tosoh Silica Corporation, and AEROSIL (registered trade name) series amorphous silica products available from Nippon Aerosil Co., Ltd.

The proportion of the amorphous silica is limited to not less than 10 parts by mass as described above, particularly preferably not less than 15 parts by mass, based on 100 parts by mass of the overall rubber component.

If the proportion of the amorphous silica is less than the aforementioned range, the reinforcing effect is liable to be insufficient, thereby impairing the mechanical properties of the sheet conveying roller.

The proportion of the amorphous silica is preferably not greater than 50 parts by mass, particularly preferably not greater than 30 parts by mass, within the aforementioned range.

If the proportion of the amorphous silica is greater than the aforementioned range, the rubber composition is liable to have an excessively high viscosity, thereby making the molding difficult. Further, the sheet conveying roller is liable to have a higher permanent elongation and a higher compression set, thereby suffering from compressive deformation, rotative slippage and other inconvenience.

Where the proportion of the amorphous silica falls within the aforementioned range, in contrast, it is possible to impart the sheet conveying roller with excellent mechanical properties, while imparting the rubber composition with a proper viscosity.

The type of the silica is limited to the amorphous silica for the following reason. Even if crystalline silica is blended in the same proportion or in a greater proportion in the rubber composition, it will be impossible to provide a comparable reinforcing effect and to impart the sheet conveying roller with sufficient mechanical properties.

### <Calcium Carbonate>

Examples of the calcium carbonate include various types of synthetic calcium carbonates and heavy calcium carbonates having different particle diameters and classified according to the production method thereof, calcium carbonates surface-treated with at least one of fatty acids, quaternary ammonium salts, rhodinic acid, lignin and the like, and modified calcium carbonates having outermost surfaces treated with a silane coupling agent. These calcium carbonates may be used alone or in combination.

Specific examples of the calcium carbonate include SOFTON series heavy calcium carbonates available from Shiraishi Calcium K.K., WHITON (registered trade name) series calcium carbonates available from Shiraishi Kogyo K.K., and HAKUENKA (registered trade name) series and LITON series synthetic calcium carbonates and surface-treated calcium carbonates available from Shiraishi Kogyo K.K.

The proportion of the calcium carbonate may be properly determined according to the use purpose of the sheet conveying roller.

A so-called sheet feed roller such as a pick-up roller, a feed roller or a retard roller adapted to separately feed sheets one by one from a sheet cassette or a sheet tray into an electrophotographic image forming apparatus such as a laser printer is required to have a higher friction coefficient.

Therefore, a sheet conveying roller to be used as the sheet feed roller is required to be more flexible. Since the rubber composition contains not less than 10 parts by mass of the amorphous silica based on 100 parts by mass of the overall rubber component as described above, it is preferred to use the oil-extension type rubber as at least a part of the rubber component or to add a plasticizer, a processing aid, an oil or the like to the rubber composition in order to prevent the sheet conveying roller from becoming harder. Further, it is preferred to blend the calcium carbonate in a minimum proportion necessary to suppress the inhibition of the crosslinking of the EPDM.

More specifically, the proportion of the calcium carbonate is preferably not less than 0.5 parts by mass and not greater than 15 parts by mass, more preferably not greater than 12 parts by mass, particularly preferably not less than 1 part by mass and not greater than 10 parts by mass.

If the proportion of the calcium carbonate is less than the aforementioned range, it will be impossible to sufficiently provide the effect of the combinational use of the amorphous silica and the calcium carbonate for substantially preventing the amorphous silica from inhibiting the crosslinking of the EPDM, thereby impairing the mechanical properties of the sheet conveying roller.

If the proportion of the calcium carbonate is greater than the aforementioned range, on the other hand, the intended effect will not be further enhanced, but the sheet conveying roller is liable to have an excessively high hardness and cannot be properly used as the sheet feed roller.

A so-called transport roller such as a registration roller or a sheet output roller adapted to transport a sheet to the subsequent section in the image forming apparatus or the inkjet printer is often required to have a higher hardness.

Therefore, it is preferred to select a non-oil-extension type rubber as the rubber component, or to increase the proportion of the calcium carbonate in proper balance with the proportion of the amorphous silica.

More specifically, the proportion of the calcium carbonate is preferably greater than 15 parts by mass and not greater than 100 parts by mass, more preferably not less than 30 parts by mass, particularly preferably not less than 40 parts by mass and not greater than 50 parts by mass, based on 100 parts by mass of the overall rubber component.

### <Other Reinforcing Agent and Filler>

The inventive rubber composition may further contain other reinforcing agent and filler.

Examples of the other reinforcing agent and filler include carbon black, titanium oxide, zinc oxide, silica compounds other than the amorphous silica, clay, talc, magnesium carbonate and aluminum hydroxide, which may be used alone or in combination.

Usable examples of the carbon black include various grades of carbon black functioning as a rubber reinforcing agent.

The proportion of the carbon black is preferably not less than 0.05 parts by mass and not greater than 3 parts by mass, particularly preferably not less than 0.1 part by mass and not greater than 1.5 parts by mass, based on 100 parts by mass of the overall rubber component.

Usable examples of the titanium oxide include anatase type titanium oxide and rutile type titanium oxide which are classified according to the crystalline structure thereof.

The proportion of the titanium oxide is preferably not less than 0.5 parts by mass and not greater than 5 parts by mass, particularly preferably not less than 1 part by mass and not greater than 3 parts by mass, based on 100 parts by mass of the overall rubber component.

### <Other Ingredients>

The rubber composition may further contain a crosslinking assisting agent.

A variety of compounds capable of assisting the peroxide crosslinking agent in crosslinking the rubber component are usable as the crosslinking assisting agent.

Usable examples of the crosslinking assisting agent include co-crosslinking agents including higher methacrylates such as trimethylpropane trimethacrylate, and triallyl isocyanurate (TAIC), sulfur, dibenzoylquinone dioxime and 1, 2-polybutadienes.

The proportion of the crosslinking assisting agent is preferably not less than 1 part by mass and not greater than 5 parts by mass based on 100 parts by mass of the overall rubber component.

As required, the rubber composition may further contain a silane coupling agent, a coloring agent such as a pigment, an anti-aging agent, a plasticizing agent, a processing aid, an oil and the like in proper proportions.

Examples of the plasticizing agent include plasticizers such as dibutyl phthalate (DBP), dioctyl phthalate (DOP) and tricresyl phosphate, and waxes such as polar waxes. Examples of the processing aid include fatty acids such as stearic acid. Examples of the oil include process oils.

The proportion of the plasticizing agent is properly determined according to a required hardness of the sheet conveying roller.

Where the oil extension type EPDM is used as the rubber component, the addition of the plasticizing agent may be obviated, or the proportion of the plasticizing agent may be reduced according to the amount of the extension oil.

### <<Sheet Conveying Roller>>

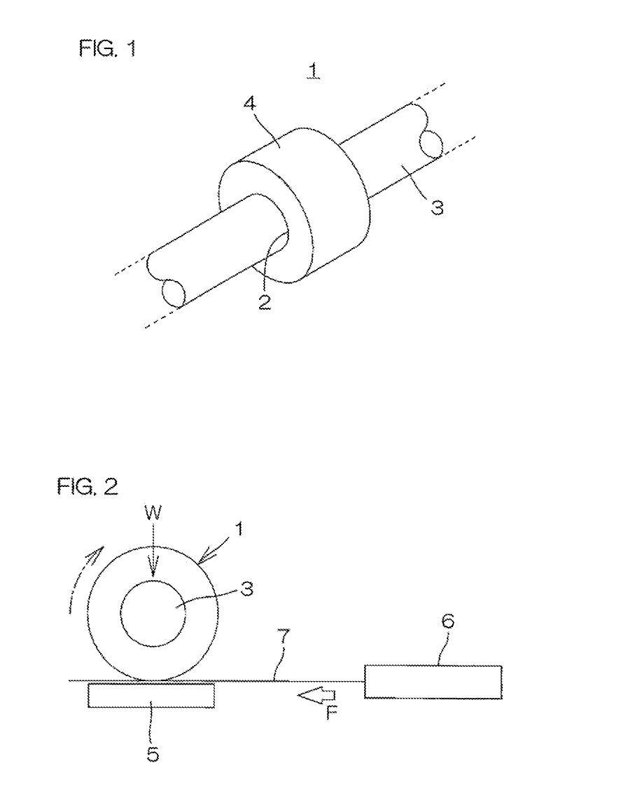

FIG. 1 is a perspective view illustrating an exemplary sheet conveying roller according to one embodiment of the present invention.

Referring to FIG. 1, the sheet conveying roller 1 according to this embodiment is produced by forming the inventive rubber composition into a tubular body and crosslinking the tubular body.

The sheet conveying roller 1 has a through-hole 2 having a round cross section and extending along a center line thereof, and a cylindrical shaft 3 is inserted through and fixed to the through-hole 2. An outer peripheral surface 4 of the sheet conveying roller 1 to be brought into contact with a paper sheet has a cylindrical shape coaxial with the through-hole 2 and the shaft 3.

A shaft having an outer diameter greater than the inner diameter of the through-hole 2 of the sheet conveying roller 1, for example, is used as the shaft 3, which is press-inserted into the through-hole 2, whereby the sheet conveying roller 1 and the shaft 3 are fixed to each other without rotative slippage therebetween.

That is, an interference defined by a difference in diameter between the through-hole 2 of the sheet conveying roller 1 and the shaft 3 provides a certain rotative slippage torque (a threshold torque that prevents the rotative slippage) between the sheet conveying roller 1 and the shaft 3.

The shaft 3 is made of, for example, a metal, a ceramic material, a rigid resin or the like.

A plurality of such sheet conveying rollers 1 may be fixed to the single shaft 3.

The sheet conveying roller 1 may be produced, for example, by forming the rubber composition into a tubular body by an extrusion method or the like and then crosslinking the tubular body by a press-crosslinking method or the like, or by molding and crosslinking the rubber composition in a tubular shape by a transfer-molding method or the like.

As required, the outer peripheral surface 4 of the sheet conveying roller 1 may be polished to a predetermined surface roughness, or subjected to a knurling process, an emboss process or the like at any time during the production process.

Further, opposite end portions of the sheet conveying roller 1 may be cut off so that the outer peripheral surface 4 has a predetermined width.

The outer peripheral surface 4 of the sheet conveying roller 1 may be covered with a given coating layer. Further, the sheet conveying roller 1 may have a double layer structure including an outer layer provided on the side of the outer peripheral surface 4 and an inner layer provided on the side of the through-hole 2. In this case, at least the outer layer is preferably formed from the inventive rubber composition.

However, the sheet conveying roller 1 preferably has a single-layer structure as shown in FIG. 1 for simplification of the structure thereof for production at lower costs with higher productivity.

The sheet conveying roller 1 may have a porous structure, but preferably has a substantially nonporous structure. The nonporous sheet conveying roller is substantially free from the reduction in friction coefficient μ. Further, the nonporous sheet conveying roller has a smaller compression set with a proper hardness and, therefore, is substantially free from an indentation which may otherwise occur due to the deformation of the roller when the roller is kept in contact with a part of other roller or the like for a relatively long period of time. In addition, the nonporous sheet conveying roller suppresses the reduction in rotative slippage torque with a reduced permanent elongation, and has an improved wear resistance.

The through-hole 2 may extend eccentrically from the center line of the sheet conveying roller 1 depending on the use purpose of the sheet conveying roller 1. Further, the outer peripheral surface 4 of the sheet conveying roller 1 may have an odd shape rather than the tubular shape. For example, the outer peripheral surface 4 may have a partly cut-away planar portion.

The odd-shaped sheet conveying roller 1 may be produced by forming the rubber composition directly into an odd-shaped body and then crosslinking the odd-shaped body by the aforementioned production method, or by post-processing the tubular sheet conveying roller 1 into the odd shape.

Further, a shaft 3 having an odd shape conformable to the odd shape of the sheet conveying roller 1 may be press-inserted into the through-hole 2 of the tubular sheet conveying roller 1 so as to deform the sheet conveying roller 1 into the odd shape. In this case, the processability is improved, because the polishing process, the knurling process, the emboss process and the like can be performed on the outer peripheral surface 4 of the tubular sheet conveying roller 1 before the deformation.

As described above, the inventive sheet conveying roller may be incorporated in an electrophotographic image forming apparatus such as a laser printer or in an inkjet printer for use as a sheet feed roller or a sheet transport roller, or may be incorporated in an automatic teller machine (ATM) for use as a transport roller for transporting bills or account statements.

### EXAMPLES

### <<Sheet Feed Roller>>

### Example 1

### (Preparation of Rubber Composition)

An EPDM (I) (oil-extension type EPDM ESPRENE (registered trade name) 670F available from Sumitomo Chemical Co., Ltd. and having an ethylene content of 66 mass %, a diene content of 4.0 mass % and an oil extension amount of 100 phr) was used as a rubber component.

Then, 30 parts by mass of amorphous silica (wet silica Nipsil VN3 available from Tosoh silica Corporation), 3 parts by mass of calcium carbonate (I) (SOFTON 3200 available from Shiraishi Calcium K.K., and having an average particle diameter of 0.7 μm, a specific surface area of 32000 cm²/g and a DOP oil absorption amount of 41 ml/100 g), 0.1 part by mass of carbon black (DIABLACK (registered trade mark) H available from Mitsubishi Chemical Corporation), 2 parts by mass of titanium oxide (anatase type titanium oxide SA-1 available from Sakai Chemical Industry Co., Ltd.) and 3 parts by mass of dicumyl peroxide (peroxide crosslinking agent PERCUMYL (registered trade name) D available from NOF Corporation) were blended with 200 parts by mass of the EPDM (I) (an EPDM solid content of 100 parts by mass), and the resulting mixture was kneaded by means of a 3 L kneader and an open roll. Thus, a rubber composition was prepared.

### Comparative Example 1

A rubber composition was prepared in substantially the same manner as in Example 1, except that the calcium carbonate (I) was not blended.

### Comparative Example 2

A rubber composition was prepared in substantially the same manner as in Example 1, except that the proportion of the amorphous silica was 5 parts by mass and the proportion of the calcium carbonate (I) was 1 part by mass.

### Example 2

The same EPDM (I) as used in Example 1 and an IR (Nipol (registered trade name) IR2200 available from Zeon Corporation) were used as a rubber component.

Then, 20 parts by mass of the same amorphous silica, 1 part by mass of the same calcium carbonate (I), 0.1 part by mass of the same carbon black, 2 parts by mass of the same titanium oxide and 3 parts by mass of the same dicumyl peroxide (peroxide crosslinking agent) as used in Example 1 were blended with 140 parts by mass of the EPDM (I) (an EPDM solid content of 70 parts by mass) and 30 parts by mass of the IR, and the resulting mixture was kneaded by means of a 3 L kneader and an open roll. Thus, a rubber composition was prepared.

### Example 3

A rubber composition was prepared in substantially the same manner as in Example 2, except that the proportion of the amorphous silica was 15 parts by mass, and 10 parts by mass of calcium carbonate (II) (synthetic calcium carbonate surface-treated with a fatty acid, available under the trade name of HAKUENKA CC from Shiraichi Kogyo K.K., and having a primary particle diameter of 50 nm and a BET specific surface area of 23 to 29 m²/g) was blended instead of the calcium carbonate (I).

### Comparative Example 3

A rubber composition was prepared in substantially the same manner as in Example 3, except that the calcium carbonate (II) was not blended.

### Comparative Example 4

A rubber composition was prepared in substantially the same manner as in Example 3, except that the amorphous silica was not blended.

### <Evaluation for Crosslinking State>

The rubber compositions prepared in Examples 1 to 3 and Comparative Examples 1 to 4 were each press-molded at 170° C. for 20 minutes, and checked for crosslinking. The rubber compositions of Examples 1 to 3 and Comparative Examples 2 to 4 were properly crosslinked and, therefore, rated as having excellent crosslinkability (o). Then, the following tests were performed on these rubber compositions.

However, the rubber composition of Comparative Example 1 was not properly crosslinked and, therefore, rated as having unacceptable crosslinkability (x). The following tests were not performed on the rubber composition of Comparative Example 1.

### <Mechanical Property Tests>

### (Hardness Test)

The rubber compositions prepared in Examples 1 to 3 and Comparative Examples 2 to 4 were each press-crosslinked at 170° C. for 20 minutes to be formed into a 2-mm thick sheet, and a test piece was prepared by stacking three such sheets.

The type-A durometer hardness of the test piece was measured at a temperature of 23±2° C. by a measurement method specified in Japanese Industrial Standards JIS K6253-3_{:2012} “Rubber, vulcanized or thermoplastic—Determination of hardness—Part 3: Durometer method” after a lapse of 3 seconds.

### (Tensile Test)

The rubber compositions prepared in Examples 1 to 3 and Comparative Examples 2 to 4 were each press-crosslinked at 170° C. for 20 minutes to be formed into a 2-mm thick sheet, which was in turn stamped. Thus, a dumbbell No. 3 test piece specified in Japanese Industrial Standards JIS K6251_{:2010} “Rubber, vulcanized or thermoplastic—Determination of tensile stress-strain properties” was prepared.

The tensile strength TS (MPa) and the breakage elongation E_{b} (%) of the test piece were determined when the tensile test was performed at a temperature of 23±2° C. by a test method specified in Japanese Industrial Standards JIS K6251_{:2010}.

### (Compression Set Test)

The rubber compositions prepared in Examples 1 to 3 and Comparative Examples 2 to 4 were each press-crosslinked at 170° C. for 20 minutes to be formed into a large test piece specified in Japanese Industrial Standards JIS K6262_{:2013} “Rubber, vulcanized or thermoplastic—Determination of compression set at ambient, elevated or low temperatures.”

A compression set test specified in Japanese Industrial Standards JIS K6262_{:2013} was performed on the large test piece at a temperature of 70° C. for 24 hours to determine the compression set (%) of the test piece.

### (Permanent Elongation Test)

The rubber compositions prepared in Examples 1 to 3 and Comparative Examples 2 to 4 were each press-crosslinked at 170° C. for 20 minutes to be formed into a 2-mm thick sheet, which was in turn stamped. Thus, a dumbbell No. 1 test piece specified in Japanese Industrial Standards JIS K6301_{:1995} “Vulcanized rubber physical test method” was prepared.

A permanent elongation test specified in Japanese Industrial Standards JIS K6301_{:1995} was performed on the test piece at a temperature of 23±2° C. to determine the permanent elongation PS (%) of the test piece.

### <Sheet Conveying Roller Test (I)>

### (Production of Sheet Conveying Roller)

The rubber compositions prepared in Examples 1 to 3 and Comparative Examples 2 to 4 were each transfer-molded into a cylindrical tubular body at 170° C. for 30 minutes, and a shaft 3 having an outer diameter of 17 mm was press-inserted into a through-hole 2 of the tubular body. In this state, the outer peripheral surface of the tubular body was polished to an outer diameter of 23 mm by means of a cylindrical polishing machine, and then the tubular body was cut to a length of 30 mm. Thus, a sheet conveying roller 1 was produced.

### (Friction Coefficient Test)

A paper sheet 7 having a size of 60 mm×210 mm (a P sheet (plain paper sheet) available from Fuji Xerox Co., Ltd.) was connected to a load cell 6 at one end thereof, and the other end portion of the paper sheet 7 was held between the produced sheet conveying roller 1 and a polytetrafluoroethylene (PTFE) plate 5 horizontally placed as shown in FIG. 2. In this state, a vertical load W of 1.18 N (=120 gf) was applied to the shaft 3 of the sheet conveying roller 1 as indicated by a solid line arrow in FIG. 2.

In this state, the sheet conveying roller 1 was rotated at a circumferential speed of 300 mm/second in a direction indicated by an arrow of a one-dot-and-dash line at a temperature of 23±2° C. at a relative humidity of 55±10%, and a transport force F (gf) applied to the load cell 6 was measured.

The friction coefficient μ of the sheet conveying roller 1 was determined from the following expression (1) based on the measured transport force F and the vertical load W (=120 gf):

μ=F/W (1)

### (Wear Resistance Test)

By means of the same apparatus as used in the friction coefficient test, the sheet conveying roller 1 was rotated on the paper sheet 7 fixed to the plate 5 for 10 minutes under the same conditions. Then, a mass change percentage (%) was determined from the following expression (2) based on the mass W₀ (g) and the mass W₁ (g) of the sheet conveying roller 1 measured before and after the rotation of the sheet conveying roller 1.

Mass change percentage (%)=W₀−W₁/W₀×100 (2)

The sheet conveying roller was evaluated for wear resistance based on the mass change percentage (%) thus determined.

The above results are shown in Tables 1 and 2.

TABLE 1

| | | |
|---|---|---|
| | Com- | Com- |
| Exam- | parative | parative |
| ple 1 | Example 1 | Example 2 |

Parts by mass

| | | | | |
|---|---|---|---|---|
| Rubber | EPDM (I) | 100 | 100 | 100 |
| component | (solid) | | | |
| | EPDM (II) | — | — | — |
| | IR | — | — | — |

| | | | |
|---|---|---|---|
| Amorphous silica | 30 | 30 | 5 |
| Crystalline silica | — | — | — |
| Calcium carbonate (I) | 3 | — | 1 |
| Calcium carbonate (II) | — | — | — |
| Carbon black | 0.1 | 0.1 | 0.1 |
| Titanium oxide | 2 | 2 | 2 |
| Peroxide crosslinking agent | 3 | 3 | 3 |
| Co-crosslinking agent | — | — | — |

Evaluation

| Crosslinkability | | ∘ | x | ∘ |
|---|---|---|---|---|
| Type-A hardness | | 33 | — | 27 |
| Tensile test | TS (MPa) | 7.6 | — | 3.2 |
| | E_{b} (%) | 850 | — | 750 |

| | | | |
|---|---|---|---|
| Compression set (%) | 15 | — | 14 |
| Permanent elongation (%) | 10 | — | 8 |
| Friction coefficient μ | 2.3 | — | 2.2 |
| Mass change percentage (%) | 7.5 | — | 10.5 |

TABLE 2

| | | | |
|---|---|---|---|
| | | Com- | Com- |
| Exam- | Exam- | parative | parative |
| ple 2 | ple 3 | Example 3 | Example 4 |

Parts by mass

| | | | | | |
|---|---|---|---|---|---|
| Rubber | EPDM (I) | 70 | 70 | 70 | 70 |
| component | (solid) | | | | |
| | EPDM (II) | — | — | — | — |
| | IR | 30 | 30 | 30 | 30 |

| | | | | |
|---|---|---|---|---|
| Amorphous silica | 20 | 15 | 15 | — |
| Crystalline silica | — | — | — | — |
| Calcium carbonate (I) | 1 | — | — | — |
| Calcium carbonate (II) | — | 10 | — | 10 |
| Carbon black | 0.1 | 0.1 | 0.1 | 0.1 |
| Titanium oxide | 2 | 2 | 2 | 2 |
| Peroxide crosslinking agent | 3 | 3 | 3 | 3 |
| Co-crosslinking agent | — | — | — | — |

Evaluation

| Crosslinkability | | ∘ | ∘ | ∘ | ∘ |
|---|---|---|---|---|---|
| Type-A hardness | | 40 | 38 | 34 | 34 |
| Tensile test | TS (MPa) | 6.1 | 5.6 | 7.2 | 2.1 |
| | E_{b} (%) | 580 | 550 | 800 | 430 |

| | | | | |
|---|---|---|---|---|
| Compression set (%) | 15 | 14 | 30 | 10 |
| Permanent elongation (%) | 9 | 9 | 18 | 7 |
| Friction coefficient μ | 2.0 | 2.1 | 2.2 | 2.1 |
| Mass change percentage (%) | 7.9 | 8.0 | 8.2 | 11.2 |

The results for Comparative Example 1 shown in Table 1 indicate that, where the amorphous silica is blended in the system containing the EPDM and the peroxide crosslinking agent, the amorphous silica inhibits the crosslinking of the EPDM and, therefore, the crosslinking is entirely impossible. The results for Example 1 indicate that, where the calcium carbonate is further blended in the same system, the EPDM is properly crosslinked to impart the sheet conveying roller with excellent mechanical properties.

However, the results for Comparative Example 2 indicate that, where the proportion of the amorphous silica is less than 10 parts by mass based on 100 parts by mass of the overall rubber component, the reinforcing effect of the amorphous silica is not sufficiently provided to thereby reduce the tensile strength TS and the wear resistance. In order to improve these properties to impart the sheet conveying roller with excellent mechanical properties, the proportion of the amorphous silica should be not less than 10 parts by mass based on 100 parts by mass of the overall rubber component as in Example 1.

The results for Comparative Examples 3 and 4 shown in Table 2 indicate that, in the system containing the EPDM and the IR in combination as the rubber component, the IR can be crosslinked without the blending of the calcium carbonate, but the crosslinking of the EPDM is inhibited by the amorphous silica and, therefore, the compression set and the permanent elongation PS are increased. Without the blending of the amorphous silica, the EPDM of the rubber component can be crosslinked, but the reinforcing effect of the amorphous silica is not provided and, therefore, the tensile strength TS and the wear resistance are reduced.

In contrast, the results for Examples 2 and 3 indicate that, where the amorphous silica and the calcium carbonate are blended in the same system, the EPDM of the rubber component can be sufficiently crosslinked to impart the sheet conveying roller with excellent mechanical properties.

### <<Sheet Transport Roller>>

### Example 4

### (Preparation of Rubber Composition)

An EPDM (II) (non-oil-extension type EPDM ESPRENE 505A available from Sumitomo Chemical Co., Ltd. and having an ethylene content of 50 mass % and a diene content of 9.5 mass %) was used as a rubber component.

Then, 30 parts by mass of the same amorphous silica, 40 parts by mass of the same calcium carbonate (II), 0.1 part by mass of the same carbon black, 2 parts by mass of the same titanium oxide, 3 parts by mass of the same dicumyl peroxide (peroxide crosslinking agent) as used in the aforementioned examples and 2 parts by mass of TAIC (co-crosslinking agent available from Nippon Kasei Chemical Co., Ltd.) were blended with 100 parts by mass of the EPDM (II) , and the resulting mixture was kneaded by means of a 3 L kneader and an open roll. Thus, a rubber composition was prepared.

### Comparative Example 5

A rubber composition was prepared in substantially the same manner as in Example 4, except that the calcium carbonate (II) was not blended and the proportion of the amorphous silica was 40 parts by mass.

### Example 5

The same EPDM (I) as used in Example 1 and the same EPDM (II) as used in Example 4 were used as the rubber component.

Then, 20 parts by mass of the same amorphous silica, 50 parts by mass of the same calcium carbonate (II), 0.1 part by mass of the same carbon black, 2 parts by mass of the same titanium oxide and 3 parts by mass of the same dicumyl peroxide (peroxide crosslinking agent) as used in the aforementioned examples, and 2 parts by mass of the TAIC (co-crosslinking agent) were blended with 40 parts by mass of the EPDM (I) (an EPDM solid content of 20 parts by mass) and 80 parts by mass of the EPDM (II), and the resulting mixture was kneaded by means of a 3 L kneader and an open roll. Thus, a rubber composition was prepared.

### Comparative Example 6

A rubber composition was prepared in substantially the same manner as in Example 5, except that the amorphous silica was not blended and the proportion of the calcium carbonate (II) was 80 parts by mass.

### Comparative Example 7

A rubber composition was prepared in substantially the same manner as in Example 5, except that 80 parts by mass of crystalline silica (CRYSTALITE (registered trade name) VX-S available from Tatsumori Ltd. and having an average particle diameter of 4 μm) was blended instead of the amorphous silica and the calcium carbonate (II) was not blended.

### <Evaluation for Crosslinking State>

The rubber compositions prepared in Examples 4 and 5 and Comparative Examples 5 to 7 were each press-molded at 170° C. for 20 minutes, and checked for crosslinking. The rubber compositions of Examples 4 and 5 and Comparative Examples 6 and 7 were properly crosslinked and, therefore, rated as having excellent crosslinkability (o). Then, the following tests were performed on these rubber compositions.

However, the rubber composition of Comparative Example 5 was not properly crosslinked and, therefore, rated as having unacceptable crosslinkability (x). The following tests were not performed on the rubber composition of Comparative Example 5.

### <Mechanical Property Tests>

The rubber compositions prepared in Examples 4 and 5 and Comparative Examples 6 and 7 were each evaluated for mechanical properties by performing the hardness test, the tensile test, the compression set test and the permanent elongation test described above on the rubber compositions.

<Sheet conveying roller Test (II)>
(Production of Sheet conveying roller)

The rubber compositions prepared in Examples 4 and 5 and Comparative Examples 6 and 7 were each transfer-molded into a cylindrical tubular body at 170° C. for 30 minutes, and a shaft 3 having an outer diameter of 8 mm was press-inserted into a through-hole 2 of the tubular body. In this state, the outer peripheral surface of the tubular body was polished to an outer diameter of 15 mm by means of a cylindrical polishing machine, and the tubular body was cut to a length of 25 mm. Thus, a sheet conveying roller 1 was produced.

### (Friction Coefficient Test)

A paper sheet 7 having a size of 60 mm×210 mm (a P sheet (plain paper sheet) available from Fuji Xerox Co., Ltd.) was connected to a load cell 6 at one end thereof, and the other end portion of the paper sheet 7 was held between the produced sheet conveying roller 1 and a polytetrafluoroethylene (PTFE) plate 5 horizontally placed as shown in FIG. 2. In this state, a vertical load W of 4.90 N (=500 gf) was applied to the shaft 3 of the sheet conveying roller 1 as indicated by a solid line arrow in FIG. 2.

In this state, the sheet conveying roller 1 was rotated at a circumferential speed of 300 mm/second in a direction indicated by an arrow of a one-dot-and-dash line at a temperature of 23±2° C. at a relative humidity of 55±10%, and a transport force F (gf) applied to the load cell 6 was measured.

The friction coefficient μ of the sheet conveying roller 1 was determined from the aforementioned expression (1) based on the measured transport force F and the vertical load W (=500 gf).

### (Wear Resistance Test)

By means of the same apparatus as used in the aforementioned friction coefficient test, the sheet conveying roller 1 was rotated on the paper sheet 7 fixed to the plate 5 for 10 minutes. Then, a mass change percentage (%) was determined from the aforementioned expression (2) based on the mass W₀ (g) and the mass W₁ (g) of the sheet conveying roller 1 measured before and after the rotation of the sheet conveying roller 1.

The above results are shown in Table 3.

TABLE 3

| | | | | |
|---|---|---|---|---|
| | Comparative | | Comparative | Comparative |
| Example 4 | Example 5 | Example 5 | Example 6 | Example 7 |

Parts by mass

| | | | | | | |
|---|---|---|---|---|---|---|
| Rubber | EPDM(I) (solid) | — | — | 20 | 20 | 20 |
| component | EPDM (II) | 100 | 100 | 80 | 80 | 80 |
| | IR | — | — | — | — | — |

| | | | | | |
|---|---|---|---|---|---|
| Amorphous silica | 30 | 40 | 20 | — | — |
| Crystalline silica | — | — | — | — | 80 |
| Calcium carbonate (I) | — | — | — | — | — |
| Calcium carbonate (II) | 40 | — | 50 | 80 | — |
| Carbon black | 0.1 | 0.1 | 0.1 | 0.1 | 0.1 |
| Titanium oxide | 2 | 2 | 2 | 2 | 2 |
| Peroxide crosslinking agent | 3 | 3 | 3 | 3 | 3 |
| Co-crosslinking agent | 2 | 2 | 2 | 2 | 2 |

Evaluation

| Crosslinkability | | ∘ | x | ∘ | ∘ | ∘ |
|---|---|---|---|---|---|---|
| Type-A hardness | | 70 | — | 60 | 59 | 58 |
| Tensile test | TS (MPa) | 7.8 | — | 11.2 | 3.6 | 3.9 |
| | E_{b} (%) | 250 | — | 370 | 230 | 320 |

| | | | | | |
|---|---|---|---|---|---|
| Compression set (%) | 8 | — | 7 | 9 | 4 |
| Permanent elongation (%) | 7 | — | 5 | 3 | 1 |
| Friction coefficient μ | 1.4 | — | 1.6 | 1.6 | 1.5 |
| Mass change percentage (%) | 0.18 | — | 0.29 | 0.55 | 0.68 |

The results for Comparative Example 5 shown in Table 3 indicate that, where the amorphous silica is blended in the system containing the EPDM and the peroxide crosslinking agent, the amorphous silica inhibits the crosslinking of the EPDM and, therefore, the crosslinking is entirely impossible.

The results for Comparative Examples 6 and 7 indicate that, where the amorphous silica is not blended or the crystalline silica is blended instead of the amorphous silica, the EPDM can be crosslinked, but the reinforcing effect of the amorphous silica cannot be provided. Therefore, the tensile strength TS is reduced, and the wear resistance is reduced as compared with Examples 4 and 5.

In contrast, the results for Examples 4 and 5 indicate that, where the calcium carbonate is further blended in the same system, the EPDM can be properly crosslinked to impart the sheet conveying roller with excellent mechanical properties.

This application corresponds to Japanese Patent Application No. 2015-111668 filed in the Japan Patent Office on Jun. 1, 2015, the disclosure of which is incorporated herein by reference in its entirety.

What is claimed is:

1. A rubber composition comprising:
a rubber component including an ethylene propylene diene rubber;
a peroxide crosslinking agent;
calcium carbonate; and
not less than 10 parts by mass of amorphous silica based on 100 parts by mass of the rubber component.

2. The rubber composition according to claim 1, wherein the amorphous silica is present in a proportion of not greater than 50 parts by mass based on 100 parts by mass of the rubber component.

3. A sheet conveying roller formed from the rubber composition according to claim 2.

4. The sheet conveying roller according to claim 3, wherein the calcium carbonate is present in a proportion of not less than 0.5 parts by mass and not greater than 15 parts by mass based on 100 parts by mass of the rubber component in the rubber composition.

5. The sheet conveying roller according to claim 3, wherein the calcium carbonate is present in a proportion of greater than 15 parts by mass and not greater than 100 parts by mass based on 100 parts by mass of the rubber component in the rubber composition.
